(19) United States
(12) Patent Application Publication
(10) Pub. No.: US 2021/0075255 A1
(43) Pub. Date: Mar. 11, 2021

(54) POWER SYPHONING ASSEMBLY AND METHOD FOR A PORTABLE ELECTRONIC DEVICE

(71) Applicant: PopSockets LLC, Boulder, CO (US)

(72) Inventors: Judd Nutting, Boulder, CO (US); Altan Nahum, Boulder, CO (US)

(21) Appl. No.: 17/019,082

(22) Filed: Sep. 11, 2020

Related U.S. Application Data
(60) Provisional application No. 62/898,782, filed on Sep. 11, 2019.

(51) Int. Cl. H02J 50/00; H04M 1/04; H02J 50/40

(52) U.S. Cl. CPC H02J 50/001; H02J 50/40; H02J 50/005; H04M 1/04

(57) ABSTRACT

Power syphon assemblies are described that are adapted to couple to and syphon power from a portable electronic device. The assemblies can include a body having a connector to further couple to an attachment to thereby provide power to an electronic device of or coupled to the attachment. The assemblies utilize a receiver coil to receive power from a transmitter coil within the portable electronic device, such as a Qi coil or a near field communication (NFC) coil. The assemblies can then transfer the syphoned power to the electronic device of the attachment through physical electronic connectors or wirelessly.

### CROSS REFERENCE TO RELATED APPLICATION

Priority is claimed to U.S. Provisional Patent Application No. 62/898,782, filed Sep. 11, 2019, the entire contents of which are hereby incorporated herein by reference

### FIELD OF THE DISCLOSURE

The present disclosure generally relates to attachments for portable electronic devices and, more particularly, to power syphoning attachments for portable electronic devices.

### BACKGROUND

Portable electronic devices, such as smart phones and tablets, are often housed in protective covers or cases in order to protect the device from damage, provide a grip for handling the device, and/or provide a stand for propping the device on a surface. Such cases increase the effective size of the device. Expandable devices and accessories, which may be attached directly to the device or to the case protecting the device, are used for a variety of functions, including propping the device on a surface and providing an expandable grip for handling the device. The expandable devices have decorative buttons, which may display logos, decals, symbols, or other artistic renderings.

### SUMMARY

In accordance with a first aspect, a power syphoning assembly for a portable electronic device is described herein that includes a body adapted to be secured to a portable electronic device, a receiver coil received within the body such that the receiver coil is adapted to extend along a portion of a main rear surface of the portable electronic device with the body secured thereto, a connector on the body adapted to couple to an attachment, and a power output in or adjacent to the connector configured to transfer power received at the receiver coil to an attachment coupled to the connector.

In some embodiments, the body can be a case having a main wall and one or more sidewalls extending outwardly from the main wall, where the case is adapted to releasably secure to a portable electronic device. The receiver coil may be longitudinally spaced from the connector along the main wall of the case or can include portions that extend radially outward of the connector.

In some embodiments, the body can be a platform that is adapted to be secured to a rear main surface of a portable electronic device. In one version, the platform can include a base portion and the receiver coil can be received within the base portion of the platform. In another version, the body can include an extension portion that extends outwardly from the platform and the receiver coil can be received within the extension portion. In a further embodiment, the extension portion can include an interior adhesive coating adapted to secure the extension portion to a rear main surface of a portable electronic device.

In any of the above embodiments, the power syphoning assembly can include one or more the following aspects: the power output can include a transmitter coil; the power output can include contacts exposed in the connector; the assembly can include a power storage device; the connector can include a cavity that is adapted to receive a protruding portion of an attachment; or the assembly can be provided in combination with an expandable grip body, where the expandable grip body includes a collapsible sidewall, a button coupled to the collapsible sidewall, an electronic device, a power reception device adapted to receive power from the power output of the power syphoning assembly, and a connector adapted to secure the expandable grip body to the connector of the body.

In accordance with a second aspect, methods are described for syphoning power from a portable electronic device configured as described in the above embodiments.

### BRIEF DESCRIPTION OF THE DRAWINGS

FIG. 1 is a diagrammatic view of a portable electronic device in accordance with various embodiments;

FIG. 2 is a perspective view of a first example power syphon assembly that includes a case for a portable electronic device and a centrally disposed receiver coil along with a grip attachment;

FIG. 3 is a perspective view of a second example power syphon assembly that includes a case for a portable electronic device and a longitudinally offset receiver coil along with a grip attachment;

FIG. 4 is a cross-sectional view of an example power syphon assembly that includes a case for a portable electronic device having a connector for coupling with a grip attachment;

FIG. 5 is a cross-sectional view of a third example power syphon assembly that includes a platform for securing to a portable electronic device and a receiver coil coupled to the platform;

FIG. 6 is a perspective view of a fourth example power syphon assembly that includes a platform with an extension portion for securing to a portable electronic device and a receiver coil coupled to the extension portion; and

FIG. 7 is a cross-sectional view of a grip attachment for coupling to a power syphon assembly.

### DETAILED DESCRIPTION

Generally speaking, pursuant to various embodiments, assemblies are provided that are adapted to couple to and syphon power from a portable electronic device. The assemblies can include a body having a connector to further couple to an attachment to thereby provide power to an electronic device of or coupled to the attachment. The assemblies utilize a receiver coil to receive power from a transmitter coil within the portable electronic device, such as a Qi coil or a near field communication (NFC) coil. The assemblies can then transfer the syphoned power to the electronic device of the attachment through physical electronic connectors or wirelessly. In some versions, the attachments can be grip attachments that include a base and an expanding mechanism that is movable relative to the base between a collapsed configuration and an expanded configuration. The expandable devices may further include a button coupled to the expanding mechanism.

The embodiments described herein achieve positioning of the receiver coil by mounting or coupling the body of the power syphoning assembly to the portable electronic device. The body can be a case for the portable electronic device or a structure adapted to be secured to the portable electronic device by adhesive, suction, or other suitable mechanisms. Moreover, the body of the power syphoning assembly can have a configuration to position the receiver coil along a rear surface of the portable electronic device to align the receiver coil with a desired internal coil of the portable electronic device. For example, portable electronic devices can include a Qi transmitter coil, as well as an NFC coil, either of which can be utilized to syphon power from the device if the receiver coil is sufficiently aligned therewith and configured to receive power therefrom.

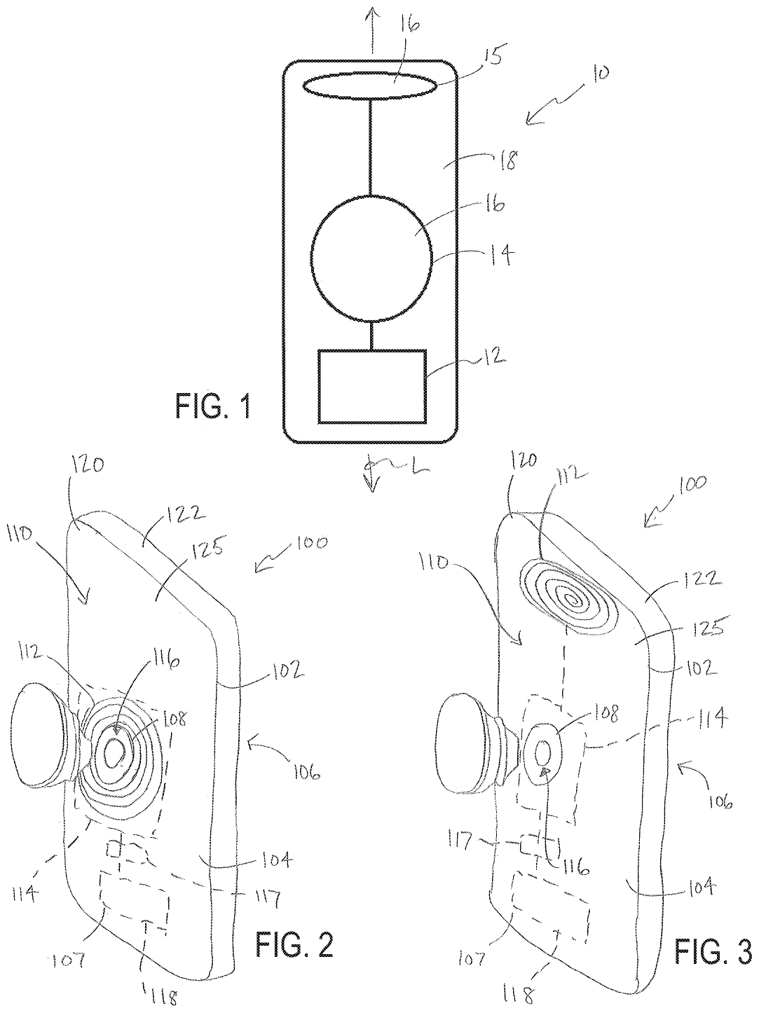

As shown in various ones of the figures, the induction syphoning assemblies and methods described herein are configured to syphon power from a suitable portable electronic device 10, such as a smart phone, tablet, e-reader, and the like. An example portable electronic device 10 is shown in FIG. 1. The portable electronic device 10 includes electronic components powered by a battery or other suitable power storage 12, a Qi coil 14 electrically coupled to the power source 12, and a NFC coil 15 electrically coupled to the power source 12. Both coils 14, 15 have a disk-shaped configuration with main surfaces 16 that extend in a direction generally parallel with respect to main surfaces 18 of the device 10. As shown, in many devices 10, the Qi coil 14 can be generally centrally located within the device 10 along a longitudinal axis L thereof, while the NFC coil 15 can be spaced from the Qi coil 14 along the longitudinal axis L to be adjacent to a top portion or bottom portion of the device 10.

Example power syphoning assemblies 100 are shown in FIGS. 2-6. The assemblies 100 include a body 102 having a wall or base 104 with an interior surface 106 adapted to extend along the rear main surface 18 of the portable device 10 and an opposite, exterior surface 107 that includes a connector 108 facing away from the interior surface 106 so that an attachment, described in more detail below, can be coupled to the body 102. The assemblies 100 further include an electronic assembly 110 disposed within and/or mounted to the body 102. The electronic assembly 110 includes a receiver coil 112 disposed within or coupled to the body 102, a circuit board 114, a power output 116. In some versions, the electronic assembly 110 can include a power storage device 118, such as a battery or capacitor, and/or electricity conditioning circuitry and/or components 117. It will be understood that the components of the electronic assembly 110 can be connected by suitable electrical connections, including traces, wires, circuit boards, etc. Further, if desired, the body 102 can include shielding 119 disposed around or adjacent to any of the components of the electronic assembly 110.

As shown in FIGS. 2-4, the body 102 is a case 120 including a main wall 104 and one or more sidewalls 122 extending outwardly from edges of the main wall 104. The sidewalls 122 are configured to engage side and/or front surfaces of the device 10 to secure the case 120 thereto. For example, the sidewalls 122 can be inwardly slanted and/or provided with a lip to engage the device 10 and can have resilient and/or flexible configurations for mounting the body 102 to the device 10, as commonly understood. With this configuration, the interior surface 106 of the main wall 104 extends along and over the rear main surface 18 of the device 10. The case 120 can be utilized to protect the portable electronic device 10 against physical damage.

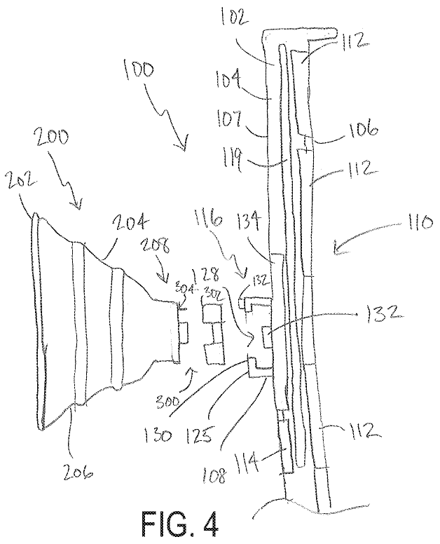

One aspect of the disclosure is to syphon power from the Qi coil 14 as shown in FIGS. 2 and 4. The receiver coil 112 is disposed within the main wall 104 of the case 120 in a generally central location and, as shown, can have a size so that the receiver coil 112 extends radially outwardly from the connector 108. In one or more embodiments, the receiver coil 112 can be coupled to the interior surface 106, or the exterior surface, of the main wall 104 using any suitable method, such as adhesive. With this configuration, when the case 120 is secured or coupled to the device 10, the receiver coil 112 is sufficiently aligned with the Qi coil 14 to enable energy transfer therebetween.

Another aspect of the disclosure is to syphon power from the NFC coil 15 as shown in FIGS. 3 and 4. The receiver coil 112 is disposed within or coupled to a surface of the main wall 104 of the case 120 longitudinally offset from a generally central longitudinal location. With this configuration, when the case 120 is secured or coupled to the device 10, the receiver coil 112 is sufficiently aligned with the NFC coil 15. Advantageously, the location of the offset coil 112 can be indicated on the case 120 to aid a user in correctly mounting the case 120 on the device 10. As illustrated, the NFC coil 15 is located in a top portion of the device 10 and, as such, the receiver coil 112 is disposed in a top half of the case main wall 104. It will be easily conceivable, however, for the receiver coil 112 to be disposed in a bottom half of the case main wall 104 for a corresponding configuration of the NFC coil 15. Similarly, it will be understood that the case 102 can be configured for a device 10 where the NFC coil 15 and Qi coil 14 are in opposite locations.

As discussed above, the case 120 further includes the connector 108 that is adapted to couple to an attachment, such as an expandable grip attachment. The connector 108 includes an outer surface 125 and a collar 126 extending away from the surface 125. The collar 126 defines a cavity 128 with one or more radially inwardly extending shelves 130 extending around an opening to the cavity 128. Other suitable connections can alternatively be utilized. For example, the connector 108 could use snap-fit structure, threads, plug and socket, a locking tab and slot, magnets, friction fit, adhesive, and so forth.

To provide syphoned power to the attachment, the power output 116 of the electronic assembly 110 is disposed adjacent to or in the connector 108. In some embodiments, the power output 116 includes contacts 132 exposed on or adjacent to the connector 108. For example, the contacts 132 can be disposed within the cavity 130 or in the outwardly facing surface 125 of the collar 126. Moreover, the power output 116 can be a transmitter coil 134 extending radially around and/or outward from the connector 108 within the body 102 or extending along the interior/exterior surface thereof. The transmitter coil 134 can have a disk-shaped configuration or an annular configuration. For example, the annular configuration can include a cylindrical configuration extending between the interior surface 106 and the exterior surface or a ring-shaped configuration with main surfaces that extend generally parallel to the interior surface 106. The transmitter coil 134 can be configured to transfer power to an induction zone spaced from the connector 108 in a region corresponding to a receiver coil of an attachment, described in more detail below.

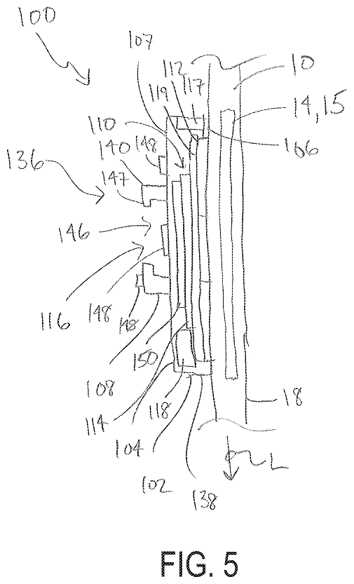

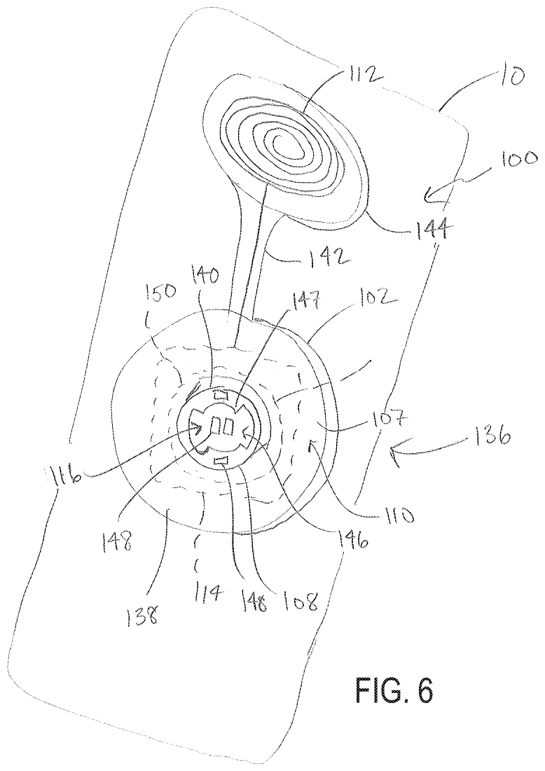

FIGS. 5 and 6 illustrate that the body 102 includes a platform 136 with a base 138 and stem or collar 140 projecting outwardly from the base 138. The base 138 is adapted to be mounted to the portable electronic device 10 or a case or other structure mounted to the device 10. The platform 136 can be secured using a suitable adhesive, for example.

One embodiment to syphon power from the Qi coil 14 is shown in FIG. 5. The receiver coil 112 can be disposed within the base 138 of the platform 136 or mounted to an interior surface thereof. With this configuration, a user can secure the platform 136 to the device 10, or structure coupled thereto, in a desired location. For example, a user can position the platform 136 in a generally central longitudinal location. With this positioning, the receiver coil 112 can be sufficiently aligned with the Qi coil 14 for an energy transfer between the Qi coil and the receiver coil 112. Alternatively, a user can position the platform 136 in a longitudinally offset location to align the platform with the NFC coil 15 so that the receiver coil 112 is sufficient aligned with the NFC coil 15 for an energy transfer therebetween. A second version to syphon power from the NFC coil 15 shown in FIG. 6. The body 102 can include an extension portion 142 that projects outwardly from the platform base 138 and the receiver coil 112 can be disposed in a distal end 144 of the extension portion 142. As illustrated, the distal end 144 is enlarged with respect to a smaller bridge of the extension portion extending from the platform base 138 to the distal end 144. With this configuration, the platform 136 can be disposed in a generally central location of the device rear main surface 18, such that the extension portion 142 extends to align the receiver coil 112 with the NFC coil 15 in the top or bottom of the device 10. It will be easily conceivable, however, that a user can alternatively position the platform 136 in a top or bottom position, so that the receiver coil 112 within the extension portion 142 is aligned with the centrally-disposed Qi coil 14. Other positioning of the built in coil 112 or extension portion 142 to syphon power from a desired coil 14, 15 is within the scope of the disclosure. The extension portion 142 can be provided with an adhesive layer so that a user can adhere the extension portion 142 in place on the device 10 or a case coupled thereto similar to a sticker.

As with the above example, the platform 136 further includes the connector 108 that is adapted to couple to an attachment, such as an expandable grip attachment. As illustrated, the connector 108 comprises an outwardly open cavity 146 in the stem 140 of the platform 136 with one or more radially inwardly extending shelves 147 extending around an opening to the cavity 146. To provide syphoned power to the attachment, the power output 116 of the electronic assembly 110 is disposed adjacent to or in the connector 108. The power output 116 includes contacts 148 exposed on or adjacent to the connector 108. For example, the contacts 148 can be disposed within the cavity 146 or on the base 138 of the platform 136. Moreover, the power output 116 may be a transmitter coil 150 extending radially around and/or outwardly from the connector 108 within the body 102. The transmitter coil 150 can have a disk-shaped configuration or an annular configuration, including a cylindrical configuration extending toward the interior surface 106 or a ring-shaped configuration with main surfaces that extend generally parallel to the interior surface 106. The transmitter coil 150 can be configured to transfer power to an induction zone spaced from the connector 108 in a region corresponding to a receiver coil of an attachment, described in more detail below.

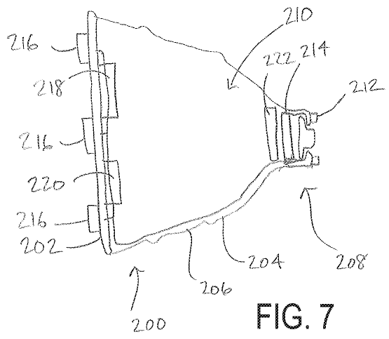

An example attachment 200 adapted to couple to the above connectors 108 is shown in FIGS. 4 and 5. The attachment 200 may be a grip attachment to aid a user in holding and standing the device 10, as well as other functionalities. The grip attachment 200 can be an expandable grip accessory in the form of a commercially available grip and stand product such as that available from PopSockets™. The attachment 200 can include a button 202 and a body 204 attached to the button 202. The body 204 is movable between an expanded configuration, as shown in FIG. 7, and a collapsed configuration. More specifically, the body 204 includes an expandable sidewall 206 with the button 202 coupled thereto and the accordion-like structure of the sidewall 206 can be shifted between a collapsed, storage configuration and an expanded configuration for use.

In some embodiments, the attachment 200 can be configured to couple to any of the above bodies 102 of the assemblies 100 shown in FIGS. 2-6. For example, the body 204 of the attachment 200 can include a connector 208 that is configured to interact with and couple to the connector 108 described above. For example, the connectors 108, 208 can have male/female connecting structure that couple together by any suitable mechanism, including, for example, threading, snap-fit, friction fit, tongue-and-groove, and so forth. If desired, the connection between the connectors 108, 208 can include a locking device 300 that includes a hub 302 and connecting disk 304 that is rotatably coupled to the body 204. An example connection is described in U.S. Pat. No. 10,348,352, issued Jul. 9, 2019, which is hereby incorporated herein for all purposes.

As shown, in FIG. 7, the attachment 200 can include an electronic assembly 210 configured to receive power from the electronic assembly 210 of the body 102. The electronic assembly 210 includes at least one of contacts 212 exposed on an exterior of the attachment 200 and configured to electrically engage the contacts 132, 148 of the body 102 when the attachment 200 is coupled to the connectors 108, 208 or a secondary receiver coil 214 to receive power from the transmitter coil 134, 150 of the body. The electronic assembly 210 further includes one or more electronic devices 216 that are electrically coupled to the contacts 212 and/or secondary receiver coil 214. If desired, the electronic assembly 210 can also include a power storage device 218, such as a battery or capacitor, and/or electricity conditioning circuitry or components 220. It will be understood that the components of the electronic assembly 210 can be connected by suitable electrical connections, including traces, wires, circuit boards, etc. For example, wires, traces, or other electrical connections can be flexible to expand and collapse with the body 204. Further, if desired, the attachment 200 can include shielding 222 disposed around or adjacent to any of the components of the electronic assembly 210.

The one or more electronic devices 216 can be any suitable devices, including, for example, one or more LED lights disposed on the body 204 and/or button 202, optionally in an array, batteries, game controls, weather sensors, camera flashes, camera lenses, electrophysiology sensors, data storage devices, keyboards, glucose monitors, body fat monitors, breathalyzers, ultrasound transducers, pulse oximeters, speakers, screens, chargers, sockets or ports to receive plugs from external device, transceivers, etc.

So configured, the above assemblies 100 can be utilized to syphon power from a portable electronic device 10 to power one or more electronic devices 218 of an attachment 200. The method of syphoning power can include receiving power from an internal coil, either the Qi coil 14 or the NFC coil 15 of the portable electronic device 10 at the receiver coil 112 of the power syphoning assembly 100 after the assembly 100 has been coupled to the portable electronic device 10. The method can then include transferring the power to the power output 116 of the power syphoning assembly 100 and transferring the power from the power output 116, which can include contacts 132, 148, or a transmitter coil 134, 150, to the power input 212, 214 of the attachment 200 to thereby power the electronic device 218 of the attachment 200.

As discussed above, the body 102 of the power syphoning assembly 100 can be attached to the portable electronic device 10 such that the 112 receiver coil received within the body 102 extends along a portion of the main rear surface 18 of the portable electronic device 10. This can include securing the case 120 including the main wall 104 and one or more sidewalls 122 extending outwardly from the main wall 104 around corresponding surfaces of the portable electronic device 10 or adhering the platform 136 of the body 102 of the power syphoning assembly 100 to the rear main surface 18 of the portable electronic device 10. In some instances, the expandable grip accessory of the current disclosure may be configured in accordance with the commercially available grip and stand product available from PopSockets™. For example, U.S. Pat. No. 8,560,031, filed on Feb. 23, 2012; U.S. Pat. No. 9,970,589, filed on Nov. 9, 2017; U.S. application Ser. No. 15/615,900, filed on Jun. 7, 2017; U.S. application Ser. No. 15/679,934, filed on Aug. 17, 2017; U.S. application Ser. No. 15/803,410, filed on Nov. 3, 2017; U.S. application Ser. No. 15/808,076, filed on Nov. 9, 2017; U.S. application Ser. No. 15/864,402, filed on Jan. 8, 2018; U.S. application Ser. No. 15/864,509, filed on Jan. 8, 2018; U.S. application Ser. No. 15/906,920, filed on Feb. 27, 2018; U.S. application Ser. No. 15/922,601, filed on Mar. 15, 2018; U.S. application Ser. No. 15/952,025, filed on Apr. 12, 2018; U.S. application Ser. No. 15/993,458, filed on May 30, 2018; and U.S. application Ser. No. 16/001,723, filed on Jun. 6, 2018 each describe suitable expandable/collapsible mechanisms, the entirety of each being hereby incorporated by reference.

It will be appreciated that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments. The same reference numbers may be used to describe like or similar parts. Further, while several examples have been disclosed herein, any features from any examples may be combined with or replaced by other features from other examples. Moreover, while several examples have been disclosed herein, changes may be made to the disclosed examples within departing from the scope of the claims.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

The patent claims at the end of this patent application are not intended to be construed under 35 U.S.C. § 112(f) unless traditional means-plus-function language is expressly recited, such as “means for” or “step for” language being explicitly recited in the claim(s).

What is claimed is:

1. A power syphoning assembly for a portable electronic device, the assembly comprising:
a body adapted to be secured to a portable electronic device;
a receiver coil received within the body such that the receiver coil is adapted to extend along a portion of a main rear surface of the portable electronic device with the body secured thereto;
a connector on the body adapted to couple to an attachment; and
a power output in or adjacent to the connector configured to transfer power received at the receiver coil to an attachment coupled to the connector.

2. The assembly of claim 1, wherein the power output comprises a transmitter coil.

3. The assembly of claim 1, wherein the power output comprises contacts exposed in the connector.

4. The assembly of claim 1, further comprising a power storage device.

5. The assembly of claim 1, wherein the body comprises a case having a main wall and one or more sidewalls extending outwardly from the main wall, the case adapted to releasably secure to a portable electronic device.

6. The assembly of claim 5, wherein the receiver coil is longitudinally spaced from the connector along the main wall of the case.

7. The assembly of claim 5, wherein the receiver coil includes portions extending radially outward of the connector.

8. The assembly of claim 1, wherein the body comprises a platform adapted to be secured to a rear main surface of a portable electronic device.

9. The assembly of claim 8, wherein the platform comprises a base portion and the receiver coil is received within the base portion of the platform.

10. The assembly of claim 8, wherein the body further comprises an extension portion extending outwardly from the platform, and the receiver coil is received within the extension portion.

11. A method of syphoning power from a portable electronic device to power an electronic device of an attachment, the method comprising:
receiving power from an internal coil of the portable electronic device at a receiver coil of a power syphoning assembly coupled to the portable electronic device;
transferring the power to a power output of the power syphoning assembly;
transferring the power from the power output to a power input of the attachment to thereby power the electronic device of the attachment.

12. The method of claim 11, wherein receiving power from the internal coil of the portable electronic device comprises receiving power from a Qi coil of the portable electronic device.

13. The method of claim 11, wherein receiving power from the internal coil of the portable electronic device comprises receiving power from a near field communication coil of the portable electronic device.

14. The method of claim 11, wherein transferring the power from the power output to the power input of the attachment comprises transferring the power from a transmitter coil to an attachment receiver coil.

15. The method of claim 11, transferring the power from the power output to the power input of the attachment comprises transferring the power from contacts of the power syphoning assembly to contacts of the attachment through a physical connection therebetween.

16. The method of claim 11, further comprising attaching a body of the power syphoning assembly to a portable electronic device such that a receiver coil received within the body extends along a portion of a main rear surface of the portable electronic device.

17. The method of claim 16, wherein attaching the body of the power syphoning assembly to a portable electronic device comprises securing a case including a main wall and one or more sidewalls extending outwardly from the main wall around corresponding surfaces of a portable electronic device.

18. The method of claim 16, wherein attaching the body of the power syphoning assembly to a portable electronic device comprises adhering a platform of the body of the power syphoning assembly to a rear main surface of a portable electronic device.

19. The method of claim 16, further comprising coupling the attachment to a body of the power syphoning assembly.
